(19) United States
(12) Patent Application Publication
(10) Pub. No.: US 2022/0412565 A1
(43) Pub. Date: Dec. 29, 2022

(54) Washable Cooking Apparatus

(71) Applicant: Andrew David Trickett, Upper Turon, New South Wales (AU)

(72) Inventor: Andrew David Trickett, Upper Turon, New South Wales (AU)

(21) Appl. No.: 17/775,444

(22) PCT Filed: Nov. 11, 2020
(86) PCT No.: PCT/AU2020/051226

§ 371 Date: May 9, 2022

(30) Foreign Application Priority Data
Nov. 11, 2019 (AU) 2019904232

(51) Int. Cl. F24B 13/00; A47J 37/07; F24B 1/00

(52) U.S. Cl. CPC F24B 13/006; A47J 37/0713; F24B 1/003

(57) ABSTRACT

There is disclosed herein a cooking apparatus (10) including: a burner assembly (17) including at least one burner (44) supported by a stand (46), the stand (46) including a magnetically attractive material; a body (14) including a cavity (16) in which the burner assembly (17) is locatable and being adapted to support a cooking surface (20) at least partially over the cavity (16), the cavity (16) including a drain (32) and substantially smooth surfaces (34) arranged to direct a fluid to the drain (32); a gas port (42) fitted to the body (14) to provide the at least one burner (44) with gas; and a magnetic coupling means (50) arranged to releasably couple with the magnetically attractive material of the stand (46); wherein the cooking apparatus (10) is configurable between: a cooking mode in which the burner assembly (17) is fitted to the gas port (42) with the stand (46) supported and located relative to cavity (16) by the magnetic coupling means (50), and the cooking surface (20) is fittable at least partially thereover, and a cleaning mode in which the cooking surface (20) and burner assembly (17) are removeable from the cavity (16), with the magnetic coupling means (50) being decoupled, to reveal the substantially smooth surfaces (34) for cleaning with the fluid.

### FIELD

The invention relates to a washable cooking apparatus. More specifically, the invention relates to a washable cooking apparatus in the form of a barbeque, camp cooker, or commercial cooking hob.

### BACKGROUND

Cooking apparatuses such as barbeques may include a body supporting a cooking plate or grill and burners under the cooking plate or grill. The body may be fitted with a hood.

Such barbeques become dirty over time with matter such as charcoal, grease and grit covering internal surfaces of the body, the cooking plate or grill and the burners. Accordingly, there is a need, from time to time, to clean the barbeque. However, barbeques may be difficult and time consuming to clean.

It is desirable to provide a washable cooking apparatus such as a barbeque, camp cooker, or commercial cooking hob that is easier and/or quicker to clean and/or has a reduced need to be cleaned.

### SUMMARY

It is an object of the present invention to substantially overcome, or at least ameliorate, one or more of the disadvantages of existing arrangements, or at least provide a useful alternative to existing arrangements.

There is disclosed herein a cooking apparatus including:

a burner assembly including at least one burner supported by a stand, the stand including a magnetically attractive material;

a body including a cavity in which the burner assembly is locatable and being adapted to support a cooking surface at least partially over the cavity, the cavity including a drain and substantially smooth surfaces arranged to direct a fluid to the drain;

a gas port fitted to the body to provide the at least one burner with gas; and

a magnetic coupling means arranged to releasably couple with the magnetically attractive material of the stand;

wherein the cooking apparatus is configurable between:
a cooking mode in which the burner assembly is fitted to the gas inlet port with the stand supported and located relative to cavity by the magnetic coupling means, and the cooking surface is fittable at least partially thereover, and
a cleaning mode in which the cooking surface and burner assembly are removeable from the cavity, with the magnetic coupling means being decoupled, to reveal the substantially smooth surfaces for cleaning with the fluid.

In an embodiment, the cavity includes at least one side wall and a base that are formed substantially continuously.

In yet another embodiment, the cavity is formed as a single piece having substantially smooth transitions between the at least one wall and base.

In yet another embodiment, the cavity is formed of a unitary metal construction, the metal being preferably stainless steel.

In yet another embodiment, the at least one side wall extends outwardly to provide a side surface or tray that is sloped to direct fluid toward the cavity.

In yet another embodiment, the cavity includes at least one groove or indent that is adapted to hold the cooking surface or other accessories in an upwardly extending position to assist with fluid draining during the cleaning mode.

In yet another embodiment, the drain is located in or at the base of the cavity. In one form, the drain is a first drain, and the cavity includes one or more further drains so as to provide a plurality of drains.

In yet another embodiment, the cavity is a first cavity, and the body includes one or more further cavities so as to provide a plurality of cavities. In a preferred form, each of the plurality of cavities is formed of a single unitary metal construction. In one form, the plurality of cavities includes an associated drain for each cavity. In an alternative form, the plurality of cavities includes a common drain.

In yet another embodiment, the magnetic coupling means is located in, at or below the base of the cavity.

In yet another embodiment, the magnetic coupling means includes one or more magnetic elements.

In yet another embodiment, the one or more magnetic elements are at least partially coated with or covered by heat proof insulation to shield against loss of magnetism from excessive heating of the one or more magnetic elements. In one form, the one or more magnetic elements are completely coated with or covered by heat proof insulation.

In yet another embodiment, the one or more magnetic elements are each disposed in a housing formed of non-ferrous material, the housing forming part of a magnet cage assembly.

In yet another embodiment, the stand of the burner assembly includes spaced apart legs arranged to coincide with the position of the magnetic coupling means.

In yet another embodiment, the legs of the burner assembly include feet arranged to seat on the base, and wherein at least the feet are formed of the magnetically attractive material.

In yet another embodiment, the magnetic coupling means includes a plurality of magnetic elements fitted to an underside of the cavity and arranged to align with the feet of the burner assembly such that the burner assembly is drawn to a preferred location within the cavity. Other accessories of the cooking apparatus may also be drawn to a preferred location within the cavity, side tray, or body.

In yet another embodiment, the burner assembly includes a handle.

In yet another embodiment, the at least one burner is adapted to releasably attach to the gas port.

In yet another embodiment, the gas port protrudes into the cavity. In another form, the gas port is recessed behind the side wall of the cavity.

In yet another embodiment, the side wall of the cavity may be flared or have a flap to protect the gas port from grease or fluid ingress.

In yet another embodiment, the burner assembly is interchangeable with an alternative heat source. In one form, the alternative heat source is charcoal supported in a charcoal housing. The charcoal housing may also incorporate gas burners that couple with the gas port for igniting the charcoal. The gas burners or charcoal housing may rest in the cavity without requiring the magnetic coupling system.

In yet another embodiment, the gas burners or charcoal housing include a spark element which is energisable by an insulated high voltage conductor.

In yet another embodiment, the gas burners or charcoal housing include a spark probe which is energisable by an inductive coil.

In yet another embodiment, the washable cooking apparatus includes an instantaneous hot water system incorporated to supply heated water to the cavity. The heated water may be supplied by way of a hand operable water source such as a hand shower, scrubber, jets or the like. The hot water system may be supplied with the same gas supply as the burners or an alternative energy source such as electricity.

In yet another embodiment, the washable cooking apparatus includes a steam generation system incorporated to supply steam for cleaning. The steam generation system may be supplied with the same gas supply as the burners or an alternative energy source such as electricity.

There is also disclosed herein a cooking apparatus including:

a body including a cavity that is adapted to support a cooking surface at least partially over the cavity, the cavity including a drain and substantially smooth surfaces arranged to direct a fluid to the drain;

a heat source locatable in the cavity and supported by a stand;

wherein the cooking apparatus is configurable between:
a cooking mode in which the stand of the heat source is supported and located relative to cavity, and the cooking surface is fittable at least partially thereover, and
a cleaning mode in which the heat source is removeable from the cavity, to reveal the substantially smooth surfaces for cleaning with the fluid.

In an embodiment, the stand includes a magnetically attractive material, and the cooking apparatus further includes a magnetic coupling means provided with the heat source, arranged to releasably couple with the magnetically attractive material of the stand, and wherein in the cooking mode, the stand of the heat source is supported and located relative to cavity by the magnetic coupling means, in the cleaning mode, the magnetic coupling means is decoupled.

In another embodiment, the heat source is a burner assembly including at least one burner, or a charcoal housing having at least one integrated burner, and wherein the at least one burner includes a handle.

In another embodiment, the cooking apparatus further includes a gas port fitted to the body to provide the at least one burner of the burner assembly or the charcoal housing with gas, and wherein in the cooking mode, the at least one burner of the burner assembly or the charcoal housing is fitted to the gas port.

In another embodiment, the cavity includes at least one side wall and a base that are formed substantially continuously, and wherein the cavity is formed as a single piece having substantially smooth transitions between the at least one wall and base.

In another embodiment, the magnetic coupling means is located in, at or below the base or side wall of the cavity or the body of the cooking apparatus, and the magnetic coupling means includes one or more magnetic elements.

In another embodiment, the cooking apparatus further includes a magnetic coupling means one or more magnet cage assemblies arranged to releasably couple with one or more accessories of the cooking apparatus.

In another embodiment, the cooking apparatus further includes a hand operable water source or spray jets to supply water to the cavity and to assist with cleaning the cooking apparatus, the hand operable water source or spray jets being fluidly connected to a hot water module.

In another embodiment, the cooking apparatus further includes an induction coil assembly operatively associated with the at least one burner of the burner assembly or the at least one integrated burner of the charcoal housing.

There is also disclosed herein a method of cleaning a cooking apparatus, the method including:

removing a cooking surface supported by a body of the cooking apparatus at least partially over a cavity of the body;

decoupling a coupling means, that may be a magnetic coupling means, associated with the burner assembly and removing the burner assembly such that the cavity is substantially free from obstruction;

applying a fluid to the cavity such that the fluid is substantially contained by the cavity so as to be directable to a drain thereof

There is also disclosed herein a cooking apparatus, such as a barbeque, including:

a burner assembly including at least one burner;

a body including a cavity in which the burner assembly is locatable and being adapted to support a cooking surface at least partially over the cavity, the cavity including a drain and substantially smooth surfaces arranged to direct a fluid to the drain;

a gas port fitted to the body to provide the at least one burner with gas,

wherein the cooking apparatus is configurable between:
a cooking mode in which the burner assembly is fitted to the gas port within the cavity and the cooking surface is fitted at least partially thereover, and
a cleaning mode in which the burner assembly and cooking surface are removeable from the cavity such that the cavity is substantially free of obstruction and washable with the fluid passing to the drain.

There is also disclosed herein a cooking apparatus including:

a heating source;

a body including a cavity in which the heat source is locatable and being adapted to support a cooking surface at least partially over the cavity, the cavity including a drain and substantially smooth and unitary surfaces arranged to direct a fluid to the drain,

wherein the cooking apparatus is configurable between:
a cooking mode in which the heat source is fittable within the cavity and the cooking surface is fitted at least partially thereover, and
a cleaning mode in which the heat source and cooking surface are removeable from the cavity such that the cavity is substantially free of obstruction and washable with the fluid passing to the drain.

There is also disclosed herein a barbeque including:

a burner assembly including at least one burner supported by a stand;

a body including a cavity in which the burner assembly is locatable and being adapted to support a cooking surface at least partially over the cavity, the cavity including a drain and substantially smooth unitary surfaces arranged to direct a fluid to the drain;

a gas port fitted to the body to provide the at least one burner with gas; and

a magnetic coupling means arranged to releasably couple the burner assembly to the cavity;

wherein the cooking apparatus is configurable between:
a cooking mode in which the burner assembly is fitted to the gas port with the stand supported by the base, with the magnetic coupling means coupled, and the cooking surface is fitted at least partially thereover, and
a cleaning mode in which the burner assembly and cooking surface are removeable from the cavity to reveal the substantially smooth unitary surfaces that are substantially free of obstruction and thereby being washable with the fluid passing to the drain.

There is also disclosed herein a cooking apparatus including:

a burner assembly including at least one burner;

a body including a cavity in which the burner assembly is locatable and being adapted to support a cooking surface at least partially over the cavity, the cavity including a drain, at least one side wall and a base that are formed to direct a fluid to the drain; and

a gas port fitted to the body to provide the at least one burner with gas,

wherein the cooking apparatus is configurable between:
a cooking mode in which the burner assembly is fitted to the gas port and the cooking surface is fitted at least partially thereover, and
a cleaning mode in which the burner assembly and cooking surface are removeable from the cavity such that the cavity is substantially free of obstruction and washable with the fluid passing to the drain.

There is also disclosed herein a cooking apparatus including:

a burner assembly including at least one burner or charcoal housing;

a body including a cavity in which the burner assembly or charcoal housing is locatable and being adapted to support a cooking surface at least partially over the cavity, the cavity including a drain, and at least one side wall and a base that are formed to direct a fluid to the drain;

a gas port fitted to the body to provide the burner assembly with gas;

a source of hot water or steam supplying a hand shower or scrubber,

wherein the cooking apparatus is configurable between:
a cooking mode in which the burner assembly is fitted to the gas port and the cooking surface is fitted at least partially thereover, and
a cleaning mode in which the burner assembly and cooking surface are removeable from the cavity such that the cavity is substantially free of obstruction and washable with the fluid passing to the drain during the washing of the burner assembly, cooking surface, cavity and accessories.

There is also disclosed herein a cooking apparatus including:

a burner assembly including at least one burner supported by a stand;

a body including a cavity in which the burner assembly is locatable and being adapted to support a cooking surface at least partially over the cavity, the cavity including a drain and substantially smooth surfaces arranged to direct a fluid to the drain, the cavity including a magnetically attractive material;

a gas port fitted to the body to provide the at least one burner with gas; and

a magnetic coupling means provided with the burner assembly and arranged to releasably couple with the magnetically attractive material of the cavity;

wherein the cooking apparatus is configurable between:
a cooking mode in which the burner assembly is fitted to the gas port with the stand supported and located relative to cavity by the magnetic coupling means, and the cooking surface is fittable at least partially thereover, and
a cleaning mode in which the cooking surface and burner assembly are removeable from the cavity, with the magnetic coupling means being decoupled, to reveal the substantially smooth surfaces for cleaning with the fluid.

### BRIEF DESCRIPTION OF THE DRAWINGS

Preferred embodiments of the invention are described, by way of non-limiting example only, by reference to the accompanying figures, in which;

FIG. 1 is a top perspective view illustrating an embodiment of a cooking apparatus in the form of a barbeque with a hood;

FIG. 2 is an underside perspective view illustrating the barbeque of FIG. 1;

FIG. 3 is a top perspective view illustrating the barbeque of FIG. 1 with the hood removed showing cooking surfaces;

FIG. 4 is a top perspective view illustrating the barbeque of FIG. 1 with the cooking surfaces removed;

FIG. 5 is an exploded parts perspective view illustrating the barbeque of FIG. 1 with additional optional components;

FIG. 6 is a top hidden detail view illustrating the barbeque of FIG. 1;

FIG. 7 is a front hidden detail view illustrating the barbeque of FIG. 1 with additional optional components;

FIG. 8 is an end hidden detail view illustrating the barbeque of FIG. 1;

FIG. 9a is a side sectional view illustrating the barbeque of FIG. 1;

FIGS. 9b to 9d are enlarged views of the gas port and jet of the barbeque of FIG. 1 in various configurations;

FIG. 10 is a top perspective view illustrating a second embodiment of a cooking apparatus in the form of a small or portable barbeque

FIG. 11 is a side sectional view illustrating a further embodiment of a barbeque;

FIG. 12 is an underside perspective view illustrating the barbeque of FIG. 11;

FIG. 13 is a top perspective view illustrating a charcoal housing of a barbeque;

FIG. 14 is a top perspective view illustrating a further embodiment of a barbeque;

FIG. 15 is a top perspective view illustrating a further embodiment of a barbeque;

FIGS. 16a and 16b are enlarged exploded views illustrating a magnet cage assembly of a barbeque;

FIGS. 17a and 17b are side views illustrating the magnet cage assembly shown in FIGS. 16 and 16b;

FIG. 18 is a top perspective view illustrating a further embodiment of a barbeque;

FIG. 19 is a top perspective view illustrating a single burner of a barbeque;

FIG. 20 is a front hidden detail view illustrating a further embodiment of a barbeque;

FIG. 21 is an exploded parts perspective view a further embodiment of a barbeque;

FIG. 22 is a front hidden detail view illustrating a further embodiment of a barbeque; and

FIG. 23 is a top perspective view illustrating an embodiment of a barbeque in the form of a camp cooker or commercial cooking hob.

### DETAILED DESCRIPTION

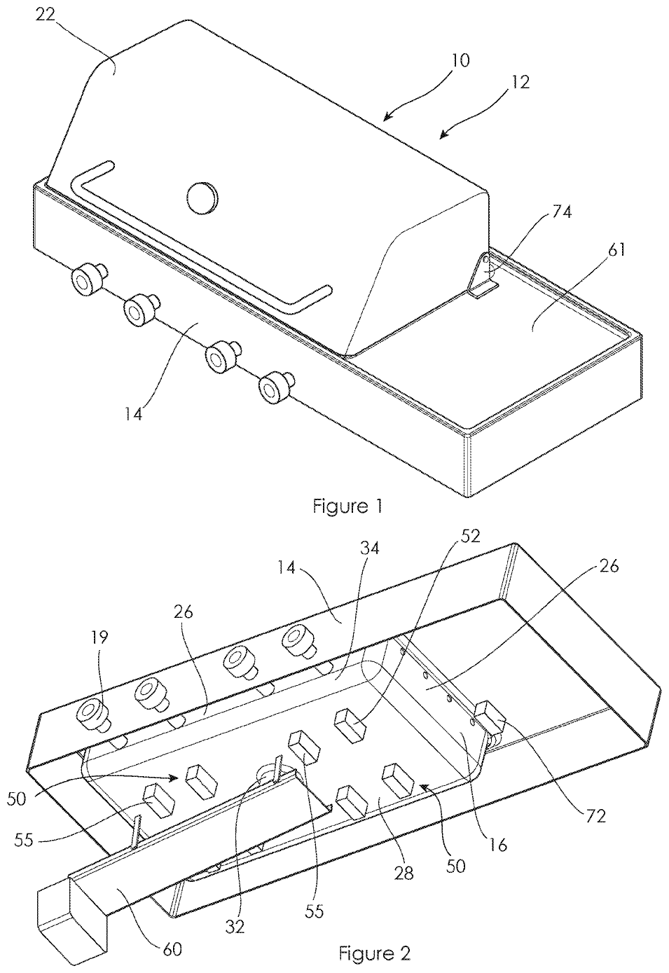

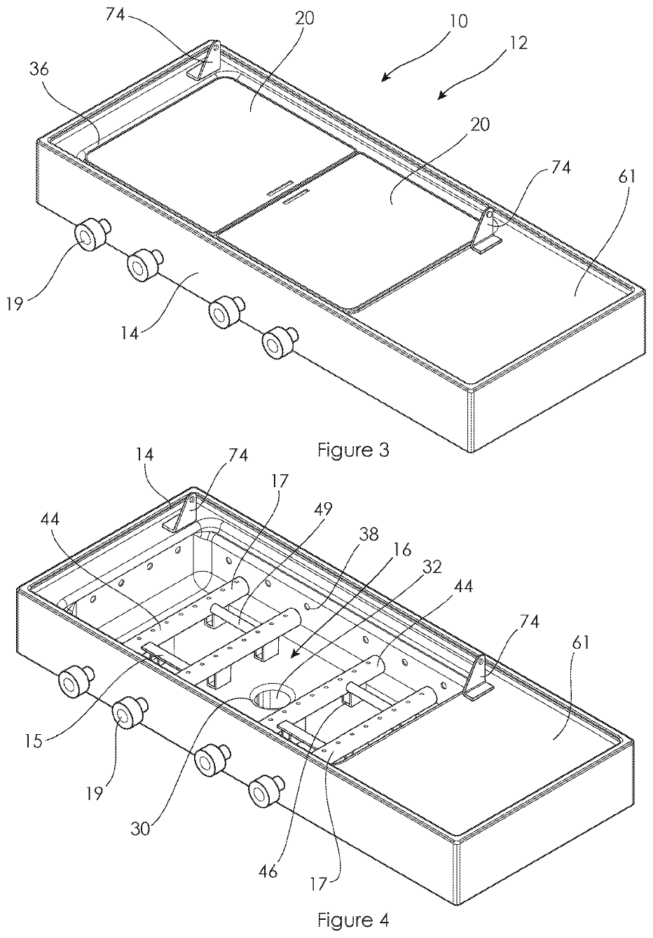

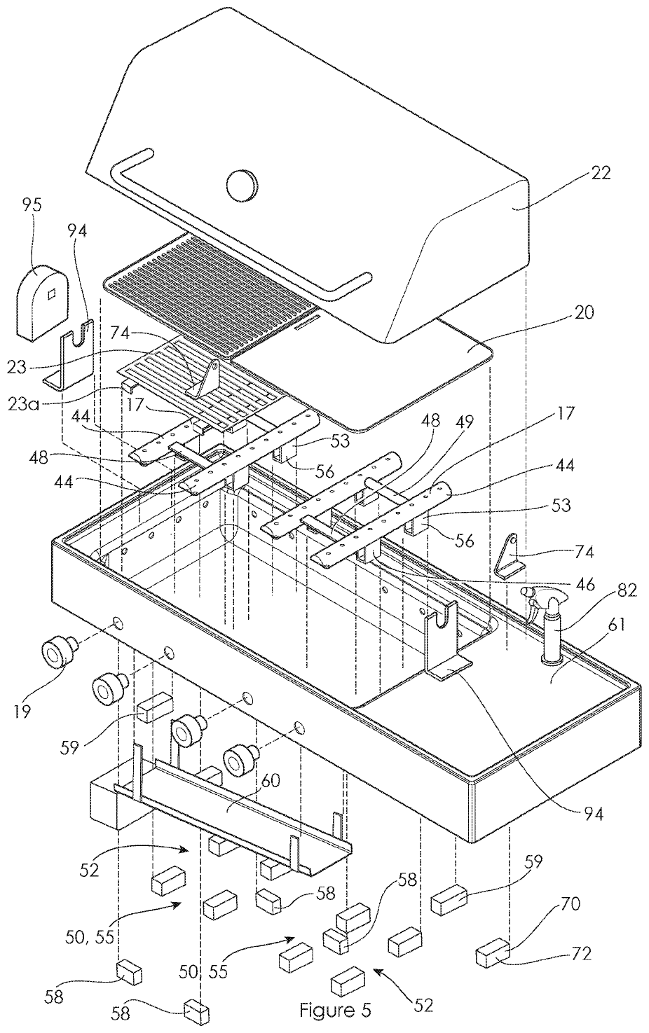

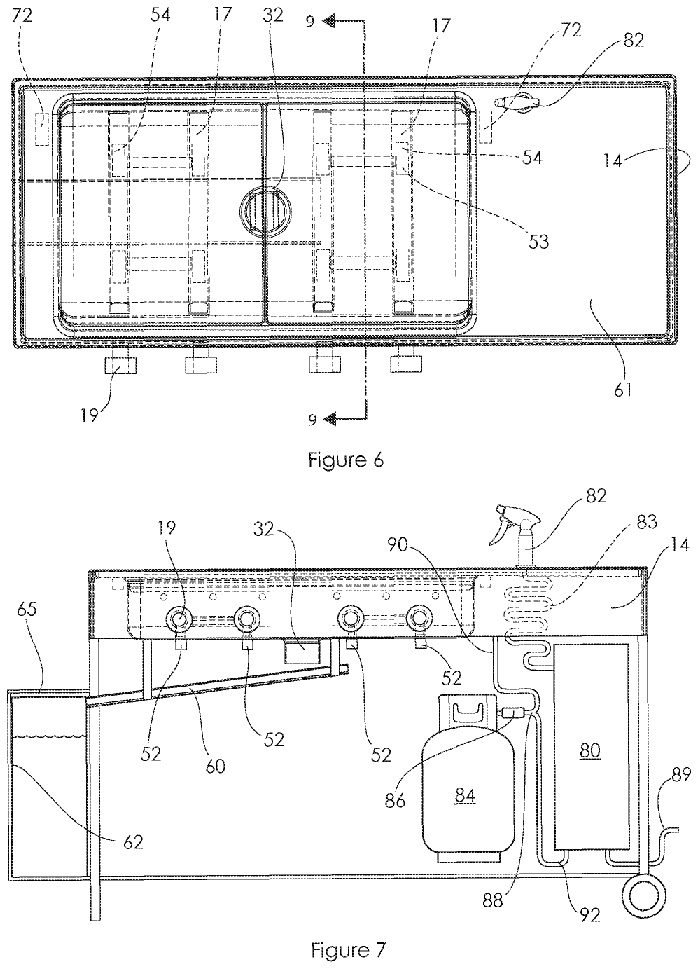

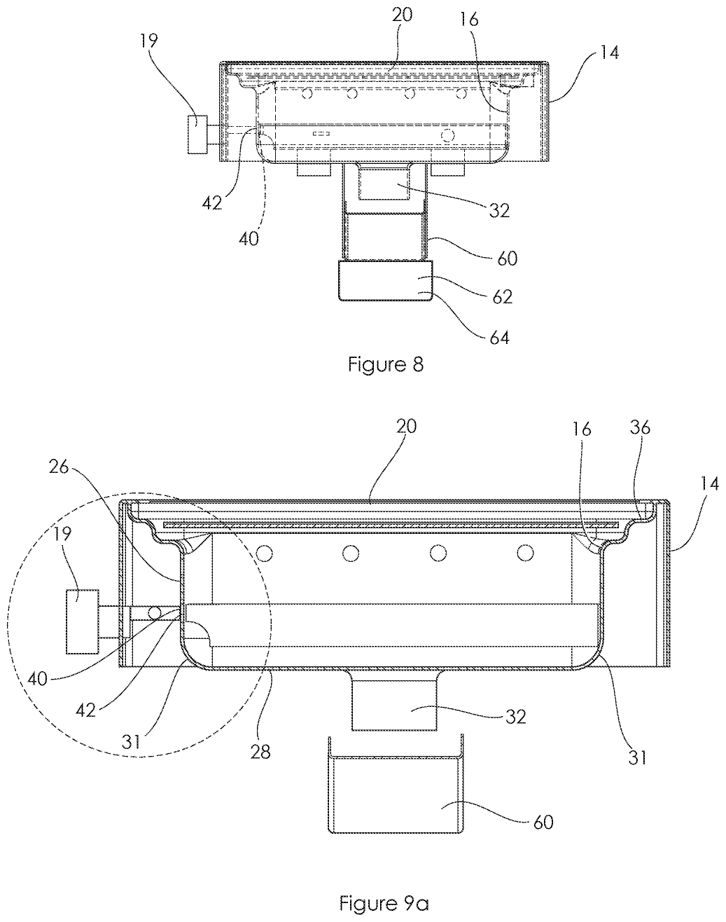

Referring to FIGS. 1 to 9d of the accompanying drawings, there is schematically depicted a first embodiment of a cooking apparatus 10 in the form of a barbeque 12. The barbeque 12 includes a body 14 with a cavity 16 in which a heat source 15 is locatable. In the depicted embodiment, the heat source 15 is in the form of a burner assembly 17. It will, however, be appreciated that other suitable forms of heat sources may be provided, as will be discussed in further detail below. In the depicted embodiment, one or more removable cooking surfaces 20, such as a hot plate or grill, is locatable above the heat source 15. The barbeque 12 may optionally be provided with a flame tamer 23 (see FIG. 5) locatable below the one or more removable cooking surfaces 20 and above the heat source 15. The flame tamer 23 may include at least one metal tab 23a to engage a corresponding magnet (for example, magnet 58 as described below) to facilitate mounting in the cavity 16. A removeable hood 22 may be fitted to the body 14 to at least partially cover or extend over the cavity 16. The body 14 of the barbeque 12 may be formed of one or multiple parts to enclose and support the cavity 16, and may be adapted to support control knobs 19 and the removeable hood 22.

The cavity 16 includes one or more side walls 26 and a base 28. Preferably, the base 28 includes an aperture 30 that provides a drain 32. The cavity 16 may be formed as a substantially unitary part so that the side walls 26 and the base 28 provide substantially smooth unitary surfaces 34 arranged to direct a fluid to the drain 32. In a preferred form, the substantially smooth unitary surfaces 34 are arranged to direct large volumes of fluid to the drain 32. It will be appreciated that junctions or corners 31 between the side walls 26 and a base 28 may be rounded or curved. The cavity 16 may be formed from a single piece of material such as, but not limited to, a metal such as stainless steel that may be press-fitted to shape. In other examples, the metal may be magnesium alloy or aluminum. In a preferred form, the metal is a non-ferritic metal. In other forms, the cavity 16 nay also be formed from a single piece of non-metal material that is preferably heat-resistant and durable (for example, carbon fiber). The shape of the cavity 16 may be, but not limited to, square, round or rectangular. The cavity 16 may be adapted, shaped or inherently adapted to reflect heat.

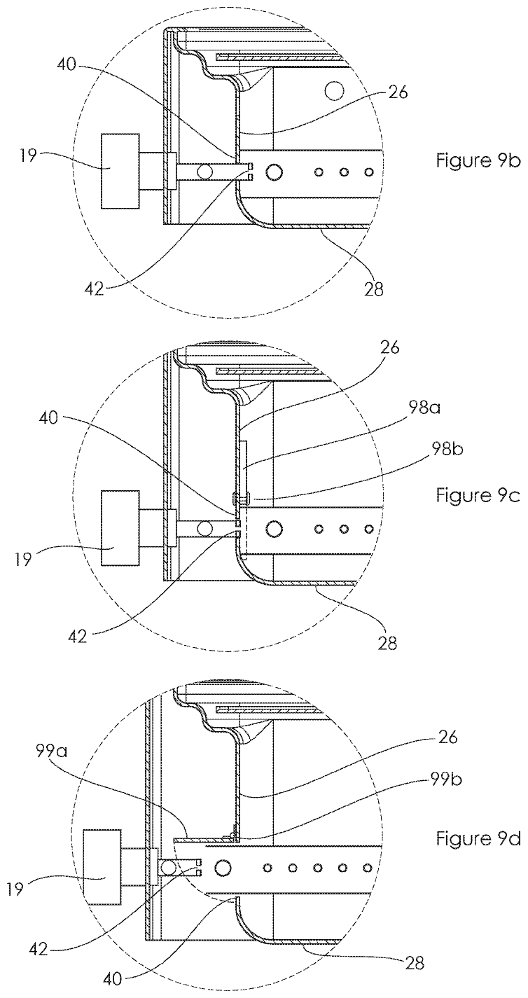

The cavity 16 may have a rim 36 (see FIGS. 1 and 9a) atop which the removable cooking surface 20 is locatable. The rim 36 may be rounded or curved. The cavity 16 may also include one or more ventilation holes 38 preferably located in or at the side walls 26 toward and below the cooking surface 20. In one form, the cavity 16 may include gas port apertures 40 through which one or more gas inlets or ports 42 extend, with the flow of gas to the gas ports 42 preferably being controllable by the control knobs 19. It will be appreciated that other controllers or actuators may be provided to control the flow of gas to the gas ports 42, such as, but not limited to, one or more levers, buttons, switches, or the like. The rim 36 may also be formed as a single piece with the cavity 16. The rim 36 may support magnets 72 to connect with the cooking surface 20 and/or the hood 22. The body 14 may include a side surface or tray 61 that is shaped to direct fluid toward the cavity 16. In one form, the side surface or tray 61 extends towards and is sloped or inclined towards the cavity 16 so as to direct fluid on the tray towards the cavity 16. The junction between the side surface or tray 61 and the cavity 16 may be curved or rounded. In some examples, the side surface or tray 61 may be also formed as single piece with the cavity 16.

In the depicted embodiment, the burner assembly 17 includes at least one burner 44 that has a tubular shape adapted to releasably couple with an associated one of the gas ports 42. In the depicted embodiment, the burner 44 includes at least one stand 46 arranged to locate the burner 44 such that the burner 44 laterally spans the cavity 16 above the base 28 in a fitted or assembled condition. As discussed above, whilst in the depicted embodiment, the heat source 15 is a burner assembly 17 adapted to burn gas, other forms of heat sources may be used. For example, the heat source 15 may be a single charcoal box, housing, basket or tray, or a combination of a charcoal box, housing, basket or tray and a burner assembly 17. These alternative arrangements will be described in further detail below. In the example where the heat source is a charcoal box, housing, basket or tray, the charcoal box, housing, basket or tray is adapted to support charcoal that is to be burnt, and, in some examples the charcoal box, housing, basket or tray may be arranged such that the charcoal supported in the charcoal box, housing, basket or tray may be ignitable with gas supplied by the gas ports 42. It will thus be appreciated that the heat source 15 may be interchangeable between different types of heat sources, such as burner assembles 17, charcoal boxes, housings, baskets, trays or the like. It will be appreciated that the heat source 15, for example the burner assembly or charcoal box, housing, basket, or tray, may not necessarily need to be coupled to the cavity by the magnetic coupling means described in further detail below. For example, the heat source 15 may be adapted to be locatable in the cavity by other suitable engagement means, such as shallow locating grooves, indents, or apertures in or on the side walls 26 or base 28 of the cavity 16. The heat source 15 may alternatively be adapted to be simply sit within the cavity without necessarily having firm locating means. The heat source 15 may, for example, be adapted to be press-fit into the cavity 16 so as to be locatable therein in use.

In the depicted embodiment, and as best shown in FIG. 4, two burner assemblies 17 are provided and each burner assembly 17 may include two parallel burners 44 (in the form of tubes) that are connected by struts (connector members) 48 (see FIG. 5), and two stands 46 extend from each burner 44 to be located above the base 28. Each of the stands 46 may be adapted to be retained by a coupling means 50 to locate and retain the stands 46 to the base 28. The struts 48 may at least provide a handle 49 to allow ease of removal of the burner assemblies 17.

The coupling means 50 includes one or more magnetic elements 52 located to attract and retain the stands 46 at coupling locations 54 of the base 28. More specifically, in the depicted embodiment, the coupling means 50 includes a series of spaced apart magnets 55 located at or below the base 28 at the coupling locations 54 and the stands 46 each includes legs 53 with feet 56 adapted to be magnetically attractive to the series of magnets 55. The legs 53 are spaced apart at the same (or generally similar) distance as the one or more magnetic elements 52 so that the burner assembly 17 is drawn to a preferred fitted location and is self-locating with the one or more magnetic elements 52. It will, however, be appreciated that the coupling means having the spaced apart magnets mag be located at any suitable location on the body 14 or the cavity 16.

In more detail, the legs 53 and/or feet 56 may be made entirely or in part of a ferritic metal such as, but not limited to, ferritic stainless steel 443. The series of magnets 55 may be any suitable magnets, but are preferably rare earth magnets. It is noted that in some examples, the configuration of the coupling means 50 could be reversed with the legs 53 carrying magnetic elements 22, and the cavity 16 including a magnetically attractive material 220 (as best shown in FIGS. 12 and 14). Both examples are contemplated herein.

The configuration described above is such that the burner assemblies 17 may be hand removable via the handle 49 by releasing the coupling means 50 and also decoupling the gas ports 42. The coupling means 50, in this case being magnetic, allows for the cavity 16 to remain relatively free of obstructions and provides the substantially smooth and rounded unitary surfaces 34. Accordingly, when the burner assemblies 17 are removed, the cavity 16 may be easily accessed for cleaning such as with a fluid, for example water, that is directed to the drain 32. The coupling means 50, in this case, being magnetic, also allows for simply toolless removal of the burner assemblies 17, and the arrangement for the stands 46 and series of magnets 55 allows the burner assemblies 17 to substantially self-locate when fitted.

Referring to FIG. 5, it will be appreciated that the cooking apparatus 10 may optionally include a pair of rotisserie stands 94 and a rotisserie motor 95 that are couplable to a rotisserie rod (not shown). The rotisserie motor 95 may be operable to drive rotation of the rotisserie rod to cook food that is attached to the rod. The rotisserie stands 94, motor 95, or other accessories may be coupled to the body 14 (for example, the surface 61) by way of one or more magnets 59. As discussed above, the one or more magnets 58 are utilised to couple the one or one metal tabs 23a of the flame tamer 23 to the body 14. It will be appreciated that the concept of the coupling means 50 including the magnets 55, or the magnets 58, or the magnets 59 described above may be integrated into any one of the embodiments of the cooking apparatus described herein.

The barbeque 12 may further include a channel 60 arranged to direct fluid, in particular large volumes of a fluid (such as cleaning fluid), from the drain 32 to a reservoir 62 that provides a collection point 64. In the embodiment as shown in FIG. 7, the reservoir 62 is shown as a large tank or bucket, however it is understood that the reservoir 62 may be any suitable size or shape to contain the fluid. The reservoir 62 may also include a covering or shroud 65 to cover an upper opening of the reservoir 62. The channel 60 may be releasably coupled the base 28 and extend toward one side of the body 14. It will be appreciated that the various components of the cooking apparatus 10, such as, but not limited to, the channel 60, burner assembly 17, or cooking surface 20, may be of suitable size and/or shape to fit in a dishwasher for cleaning purposes. The removeable hood 22 may also be connected by a further coupling means 70 that also includes a further magnetic element 72 connected to the body 14 and magnetically attractive connection tabs 74 pivotally connected to the hood 22.

To assist with cleaning, the cooking apparatus 10 may include a water source (for example, a hot water module 80 as shown in FIG. 7) that is arranged to provide water to the cavity 16 such as by water outlets located in or proximate the cavity 16, or a hand operable water source 82 such as a hand shower, scrubber, jet or similar. In the embodiment depicted in FIG. 7, the hand operable water source 82 is a hand sprayer or shower with a length of hose 83 connected to the hot water module 80. The hand operable water source 82 may therefore be supplied with hot water when activated to assist with cleaning the barbeque 12. The hot water module 80 may be in the form of an instantaneous hot water heater incorporated to supply heated water to the cavity 16. The hot water module 80 may also be in the form of a steamer unit, and may be externally powered. The hot water module 80 may be supplied with the same gas supply as the burners or an alternative energy source such as electricity. For example, and as also shown in FIG. 7, the cooking apparatus 10 may include a gas bottle 84 with a regulator 86 and splitter hose 88. A first end 90 of the splitter hose 88 is connected to the cavity 16 (e.g. the gas manifold of the barbeque 12), and a second end 92 of the splitter hose 88 is connected to the hot water module 80. The hot water module 80 may be supplied by cold water via hose fitting or inlet 89 or other connection means, for example, to a household water supply such as a garden tap. It will be appreciated that the concept of the water source, such as the hot water module and hand operable water source described above, may be integrated into any one of the embodiments of the cooking apparatus described herein.

Referring to FIGS. 9b, 9c and 9d, the gas port 42 and a jet of the gas port 42 are shown in various configurations or positions relative to the cavity 16. In FIG. 9b, the gas port 42 and jet are shown protruding through the side wall 26 of the cavity 16. In FIG. 9c, the gas port 42 and jet are shown to be flush with the side wall 26 of the cavity 16. In this arrangement, a ‘peep hole’ like cover 98a is provided, which is slightly larger than the gas port aperture 40 in the side wall 26 of the cavity 16, and which swivels from an anchor point 98b above the aperture 40 and self-locates about the aperture 40 under gravity. In FIG. 9d, the gas port 42 and jet are shown to be external to the sidewall 26 of the cavity 16. In this arrangement, a flap 99a is provided, which is slightly larger than the gas port aperture 40 in the side wall 26 of the cavity 16, with a hinge 99b which may or may not be spring loaded so that when the heat source 15 is removed, the flap 99a self-closes under gravity to close the gas port aperture 40. In other arrangements (not shown), the flap 99a may be located inside the cavity 16 and lifted manually. The purpose of the flaps or covers described above are to at least prevent leaks or over spray during a cleaning mode of the cooking apparatus, when the heat source 15 is removed from the cavity. It will be appreciated that the concept of flaps or covers described above may be integrated into any one of the embodiments of the cooking apparatus described herein.

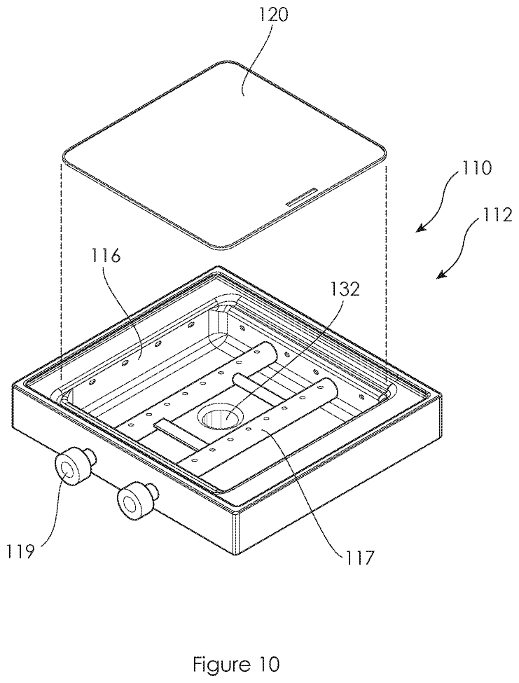

The cooking apparatus 10, in this example the barbeque 12, may be provided in different sizes, shapes and configurations such as a barbeque 12 as shown in FIG. 1 or a smaller barbeque 112 as shown in FIG. 10 that may include only a single burner assembly 117. The overall function of both examples is similar and like numbers are used to denote like parts and are not again described here.

In use, the cooking apparatus 10 is reconfigurable between a cooking mode and a cleaning mode. In the cooking mode, the heat source 15 (for example, the burner assemblies 17 described above) are fitted in fluid communication with the gas ports 42 and are located and coupled in place with the coupling means 50. The cooking surfaces 20 may also be fitted, and the hood 22 may also be coupled and closed, if required.

In the cleaning mode, the hood 22 may be opened and removed, if desired. The heat source 15 (for example the burner assemblies 17 described above) may be removed, toolless, by a user clasping the handle 49 and pulling on the burner assemblies 17 to release the magnetic force of the coupling means 50, the gas ports 42 are also decoupled using the same action. The cavity 16 is then substantially free of obstruction and may be easily accessed for cleaning such as with a fluid, for example water, that is directed to the drain 32. It is noted that in the cleaning mode with the burner assemblies 17 removed, the cooking surface 20 can be placed into the cavity 16 and cleaned in situ.

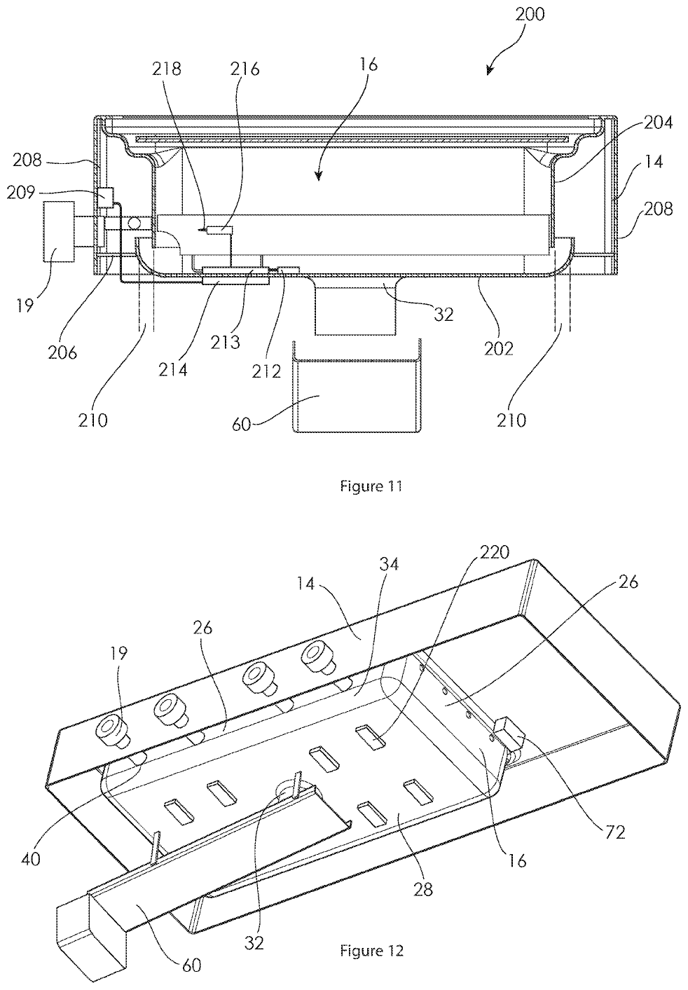

Referring to FIG. 11 of the accompanying drawings, there is schematically depicted an alternative embodiment of a cooking apparatus 200, which operates in generally the same manner as the cooking apparatus 10 described above, with like reference numerals being used to indicate like features. In this embodiment, the ventilation holes 38 described above are removed, and the cavity 16 is instead split or separated into two parts. A lower part 202 of the cavity 16 slightly larger than, and separated from, an upper part 204 of the cavity 16. The lower part 202 of the cavity 16 is provided with at least two rods or bars or rivets 206 on each side to connect the lower part 202 to the side walls 208 of the barbeque body 14, thereby holding the lower part 202 in place. A gap 210 is created between perimeter or circumference of the lower and upper parts 202 and 204. In a preferred form, the gap 210 is an air gap of approximately 15 mm in width that extends around the entire perimeter or circumference of the upper part 204. The gap 210 may alternatively have a width of between approximately 10 mm to 20 mm, depending on the design requirements of the cooking apparatus 200. The gap 210 may at least facilitate entry of secondary air into the cavity 16 and thereby assist with combustion and ventilation of the cavity 16. It will also be appreciated that an upper lip of the lower part 202 is positioned above a lower lip of the upper part 204. It will be appreciated that the concept of the lower part 202, upper part 204, and gap 210 described above may be integrated into any one of the embodiments of the cooking apparatus described herein.

In FIG. 11, the cooking apparatus 200 is shown with an induction (primary) coil 214 that is positioned about the lower part 202 of the cavity 16 (or alternatively be positioned on the side wall 26 of the cavity 16) and connected to an energising circuit 209. A secondary coil 213 may be provided in the cavity 16 and positioned to removably align with the primary coil 214. The secondary coil 213 is connected to a spark probe 218 positioned on the heat source 15, for example, a burner assembly (not shown in FIG. 11) and an earth point 212 on the cavity 16 or the burner assembly. It is envisaged that other additional components may be connected to the primary coil 214 or secondary coil 213. The energising circuit 209 may be supplied with external power, or alternatively powered by batteries. When the energising circuit 209 is activated (for example, by a button), the energising circuit 209 will excite the primary coil 214, which will in turn excite the secondary coil 213, and which will then create a small spark to ignite the gas coming out of the burner assembly. It will be appreciated that this coil and energising circuit concept may be integrated into any one of the embodiments of the cooking apparatus described herein.

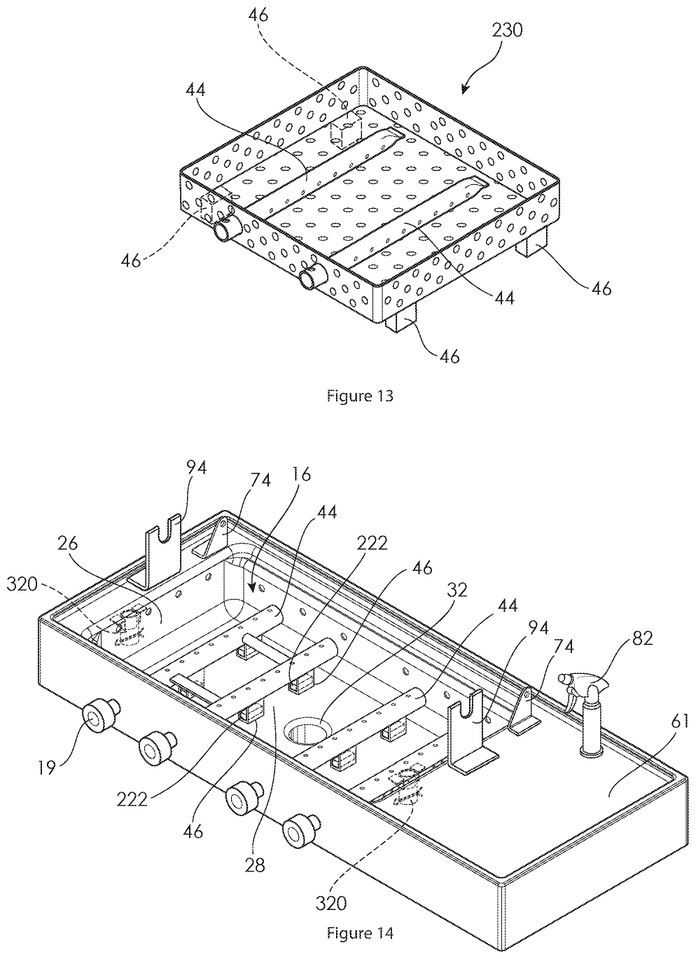

In the embodiment depicted in FIG. 12, each of the spaced apart magnets 55 described above is removed, and replaced with smaller, flat plates of ferritic metal 220. Suitable metals include steel, for example. It is envisaged that these flat plates of metal 220 are couplable with magnets 222 positioned on the stands 46 of the charcoal basket 214 as illustrated in FIG. 13 or the stands 46 of the burner assemblies 17 as illustrated in FIG. 14. It will be appreciated that the concept of the flat plates of metal 220 described above may be integrated into any one of the embodiments of the cooking apparatus described herein.

In the embodiment depicted in FIG. 13, the heat source 15 is shown in the form of a charcoal housing, box, basket or tray 230 having integrated gas burners 44. In some embodiments (not shown), the charcoal housing, box, basket or tray 230 does not necessarily need to include the integrated gas burners 44, and may simply be adapted to hold charcoal or fuel to be ignited manually. The charcoal housing, box, basket or tray 230 preferably includes a plurality of perforations or holes to facilitate air flow and one or more stands 46 to facilitate coupling to the cavity 16. The stands 46 may either be formed of ferritic material so as to be attractive to coupling means 50 with magnets 55 or to magnets 326 (inside a magnet cage 320 assembly, as will be described in further detail below). Alternatively, the stands 46 may each include the magnet 222 and thus be attracted to ferritic material either as part of the side wall 26 or base 28 of the cavity 16, or the plat plates of metal 220 located on the other side of the side wall 26 or base 28 of the cavity 16. It will be appreciated that the concept of the charcoal housing, box, basket or tray 230 described above may be integrated into any one of the embodiments of the cooking apparatus described herein.

In the embodiment depicted in FIG. 14, the barbeque 12 is shown with the cooking surface 20 removed, and the magnets 222 enclosed within or attached to the end of the stands 46 of the burners 44. In this embodiment, there is also depicted the hand operable water source 82 and the side tray 61 which is adapted to drain into the cavity 16. There is also depicted in this embodiment, two burner assemblies 17 similar to the burner assemblies described above, and in this embodiment, the stands 46 of the burners 44 each include the magnet 222 that is couplable to an associated one of the flat plates of metal 220 located at or below the base 28 and as described above. FIG. 14 also shows magnet case assemblies 320 as will be described in further detail below.

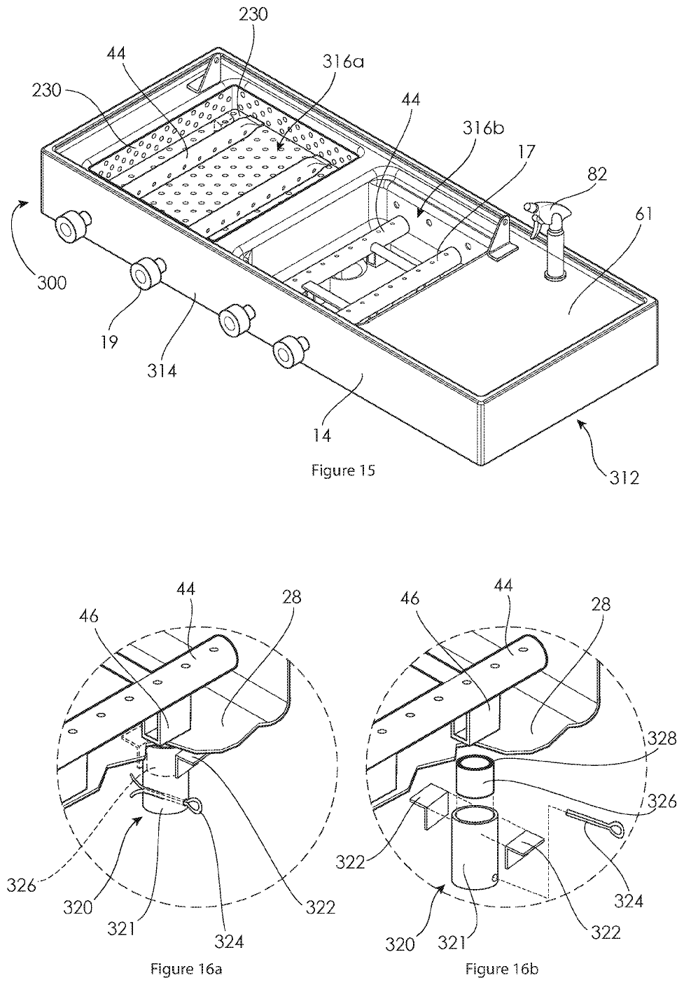

Referring to FIG. 15 of the accompanying drawings, there is schematically depicted an alternative embodiment of a cooking apparatus 300, which again operates in generally the same manner as the cooking apparatus 10 and 200 described above, with like reference numerals being used to indicate like features. In this embodiment, the cooking apparatus 300 in the form of a barbeque 312 includes a body 314 with dual cavities in the form of a first cavity 316a and a second cavity 316b. A strip or bridge 318 of metal is located in between and separates the cavities 316a and 316b. The strip or bridge 318 may be rounded or curved. The strip or bridge 318 also facilitates the movement (e.g. by sliding) of cooking surfaces 20 between the cavities 316a and 316b. In the depicted embodiment, the charcoal housing, box, basket or tray 230 (as described above with reference to FIG. 13) is locatable in the first cavity 316a (in place of the burner assembly 17), and the second cavity 316b is provided with the burner assembly 17. It will be understood that the arrangement of the charcoal housing, box, basket or tray 230 and burner assembly 17 may not necessarily be limited to what is shown in the drawings, and may be interchangeable depending on the requirements of the user. For example, each of the first and second cavities 316a and 316b may be provided with a charcoal housing, box, basket or tray 230 each, or alternatively be provided with a burner assembly 17 each. Accordingly, this embodiment demonstrates the modularity of the system being able to cook with charcoal and gas at the same time, and the benefits of a dual cavity configuration. In a preferred form, each of the plurality of cavities is formed of a single unitary metal construction. In one form, the plurality of cavities includes an associated drain for each cavity. In an alternative form, the plurality of cavities includes a common drain (for example, the drain 32 as depicted in FIGS. 14 and 15).

In FIGS. 16a and 16b, there is shown a magnet cage assembly 320 including a housing, for example in the form of a tube 321, and a fastening means such as spot weld tabs or holding lugs 322 to fasten the tube 321 to the base 28 or side wall 26 of the cavity 16 or the side tray 61 (e.g. by way of welding, gluing, or the like). The magnet cage assembly 320 also includes a holding pin, such a split pin or a cotter pin 324, a magnet 326, and heat protective portion, covering or layer 328 over the magnet 326. In one form, the magnet 326 is at least partially coated or covered with the heat protective portion, covering or layer 328 to provide heat proof insulation to shield against loss of magnetism from excessive heating of the magnet 326. In another form, the magnet 326 is completely coated or covered by the heat protective portion, covering or layer 328. It will be understood that the various components of the magnet cage assembly 320, with the exception of the magnet 326, are preferably formed of a non-magnetic material. It will be appreciated that the concept of the magnet cage assembly 320 described above may be integrated into any one of the embodiments of the cooking apparatus described herein.

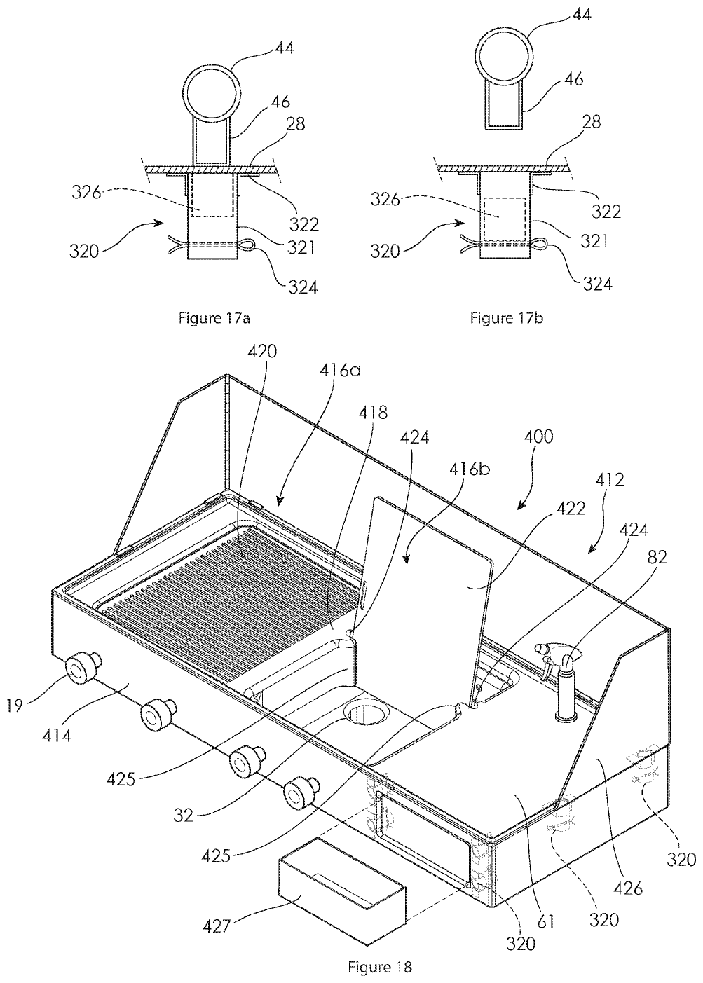

Referring to FIGS. 17a and 17b, there is schematically depicted side cross-section views of the magnet cage assembly 320 or mounted external to the cavity 16, for example, to the underside of the base 28 or the outer surface of the side wall 26 of the cavity 16. In the embodiment depicted in FIG. 17a, the stand 46 of the heat source 15 is coupled or engaged to the base 28 by way of the magnet 326 of the magnet cage 320. In the embodiment depicted in FIG. 17b, the stand 46 of the heat source 15 is de-coupled or disengaged from the base 28, and the magnet 326 is displaced by a distance away from the base 28. In a preferred form, the magnet 326 is displaced from the base 28 by a distance of about 10 mm although it will be understood that the distance that the magnet 236 is displaced may be larger or smaller, depending on the size of the magnet cage assembly 320. In the depicted embodiment, the holding pin 324 holds the magnet 326 in place within the tube 321. It will be appreciated that the displacement of the magnet 326 from the base 28 or the side wall 26 of the cavity 16 may at least allow the magnet 326 to stay cooler, and also at least reduce the impact of its magnetic field on the base 28 or sidewall 26 of the cavity 16. As with the coupling means described above, the positioning of the magnet cage assembly 320 on the outside of the cavity 16 allows any debris or fluids from the cavity 16 to easily be washed away.

Referring to FIG. 18 of the accompanying drawings, there is schematically depicted an alternative embodiment of a cooking apparatus 400, which again operates in generally the same manner as the cooking apparatus 10, 200, and 300 described above, with like reference numerals being used to indicate like features. In this embodiment, the cooking apparatus 400 in the form of a barbeque 412 includes a body 414 with dual cavities in the form of a first cavity 416a and a second cavity 416b. A strip or bridge 418 of metal is located in between and separates the cavities 416a and 416b. The strip or bridge 418 may be rounded or curved. The strip or bridge 418 also facilitates the movement (e.g. by sliding) of cooking surfaces 20 between the cavities 416a and 416b. In the depicted embodiment, the first cavity 416a is provided with an open grill plate 420. Additionally, the second cavity 416b is provided with a hot plate 422 that may be lifted (once the heat source 15 has been removed from cavity 416b) and slotted into grooves or indents 424 in the sides of the cavity 416b such that the hotplate 422 may be held in an upwardly extending position to assist with fluid draining during the cleaning mode. In a preferred form, the grooves or indents 424 are curved and enable the hotplate to extend upwardly and about 20 degrees from the vertical, although it will be understood that the curved grooves or indents 424 may hold the hotplate 424 (or any other cooking surface) at any suitable angle for cleaning. The grooves or indents 424 may either be formed in a wall of the cavity 16, or defined by an extrusion 425 projecting from a wall of the cavity 16. It will be appreciated that the curved grooves or indents 424 may be used to hold any other accessory of the cooking apparatus 400. In the depicted embodiment, a splash back accessory 426 extends around the rear and side perimeter of the barbeque 412, and is held in place by one or more of the magnetic coupling means described above, such as one or more of the magnet cage assemblies 320 as described. A utility tray accessory 427 may also be provided and coupled the body 414 of the barbeque 412 using any one of the coupling means described above, such as one or more of the magnet cage assemblies 320 as described.

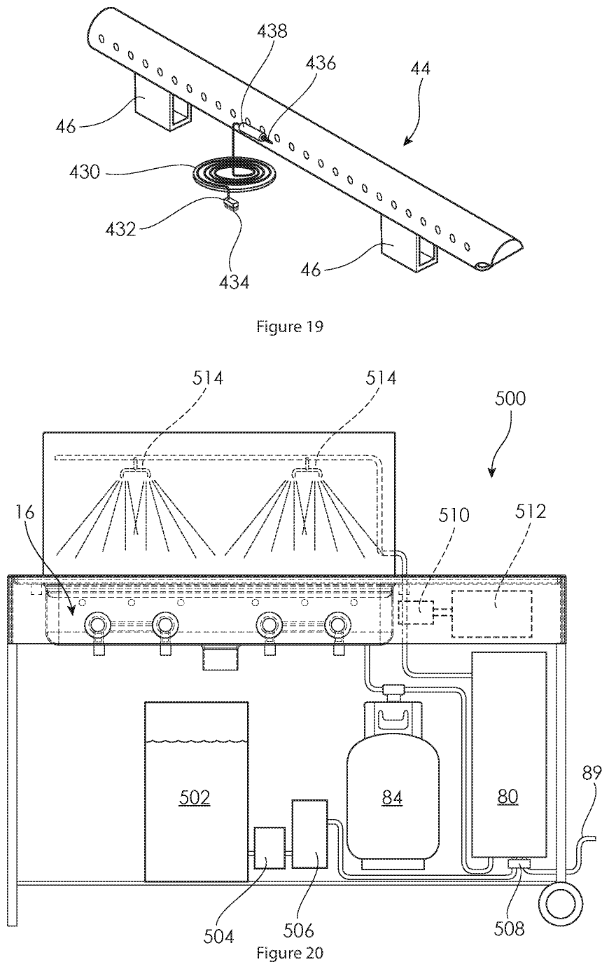

In FIG. 19, there is schematically depicted an embodiment of a single burner 44 having an induction coil 430 that is suspended below the burner 44 at or about the same height as the stands 46. A first (outer) end 432 of the coil makes contact with the base 28 or side wall 26 of the cavity 16 by way of a ground point 434 and held in place by way of a magnet. Alternatively, the ground point 434 may be fixed to one of the stands 46 of the burner 44, or to the body of the burner 44 itself. A conductor at the centre of the coil 430 extends up to a spark probe 436 having an insulation portion, for example a ceramic collar 438, which is mounted to side of the burner tube 44, and with the probe 436 preferably being located at a distance of about 3 mm from a surface of the tube 44 near a gas hole. It will, however, be understood that the probe 436 may be located at any suitable distance from the surface of the tube 44, depending on the design requirements of the cooking apparatus. It will be appreciated that the concept of the induction coil 430 and associated componentry described above may be integrated into any one of the embodiments of the cooking apparatus described herein.

In FIG. 20, there is schematically depicted a variation of a cooking apparatus 500 which again operates in generally the same manner as the cooking apparatus 10, 200, 300 and 400 described above, with like reference numerals being used to indicate like features. In this embodiment, the channel 60 and reservoir 62 are removed, and the cooking apparatus 500 is provided with the hot water module 80 described above, along with a large internal water sump 502, a filter 504, a pump 506, a selector valve or solenoid 508, a spray solenoid 510, a controller 512, and spray jets 514. The internal water sump 502 collects fluid (such as cleaning fluid) that drains from the cavity 16. The cooking apparatus 500 is also provided with the gas bottle 84 described above to supply gas to the hot water module 80, along with the hose fitting 89 described above to supply the hot water module 80. It will be appreciated that in this embodiment, external power or an internalised power source may be used so that the controller unit 512 would control the flow of water to automate a cleaning cycle to wash the cooking surfaces and/or the burners and other components of the cooking apparatus 500. The sump 502 may include sensors (not shown) to indicate one or more sump statuses such as ‘sump full’ or ‘nlid closed’. The spray jets 514 may also additionally or alternatively be incorporated inside the cavity 16 to facilitate cleaning. It will be appreciated that the concept of the automated cleaning with the internal water sump 502, filter 504, pump 506 and associated componentry described above may be integrated into any one of the embodiments of the cooking apparatus described herein. It will also be appreciated that in some embodiments, the sump 502 may not be required, and the cleaning fluid that is drained from the cavity 16 may simply be allowed to be disposed of externally and not re-used.

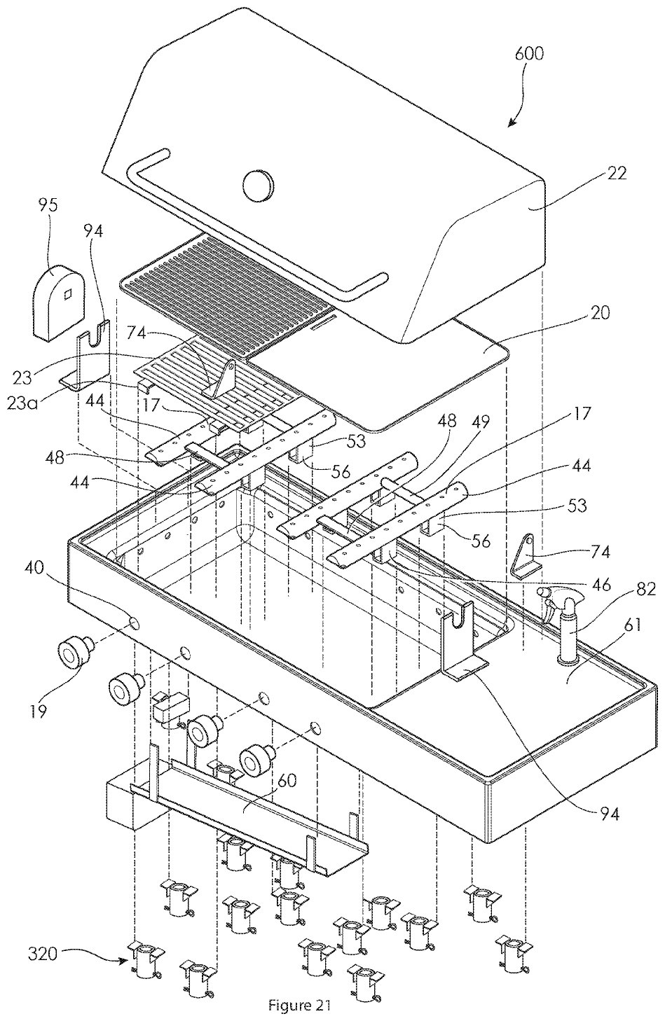

In FIG. 21, there is schematically depicted a variation of a cooking apparatus 600 which again operates in generally the same manner as the cooking apparatus 10, 200, 300, 400 and 500 described above, with like reference numerals being used to indicate like features. In this embodiment, the various components described above are shown as part of the same cooking apparatus 600, and it is envisaged that any one or more of these components may be added, removed, or interchanged with any other components described. In this depicted embodiment, a mixed arrangement is shown of magnets 55 fixed in position, or alternatively magnet cage assemblies 320 may be used to hold the cooking surfaces 20 and/or other accessories (such as the flame tamer 23, burner 44, hood 22 and hood bracket 74, rotisserie stand 94 and rotisserie motor 95) in place magnetically.

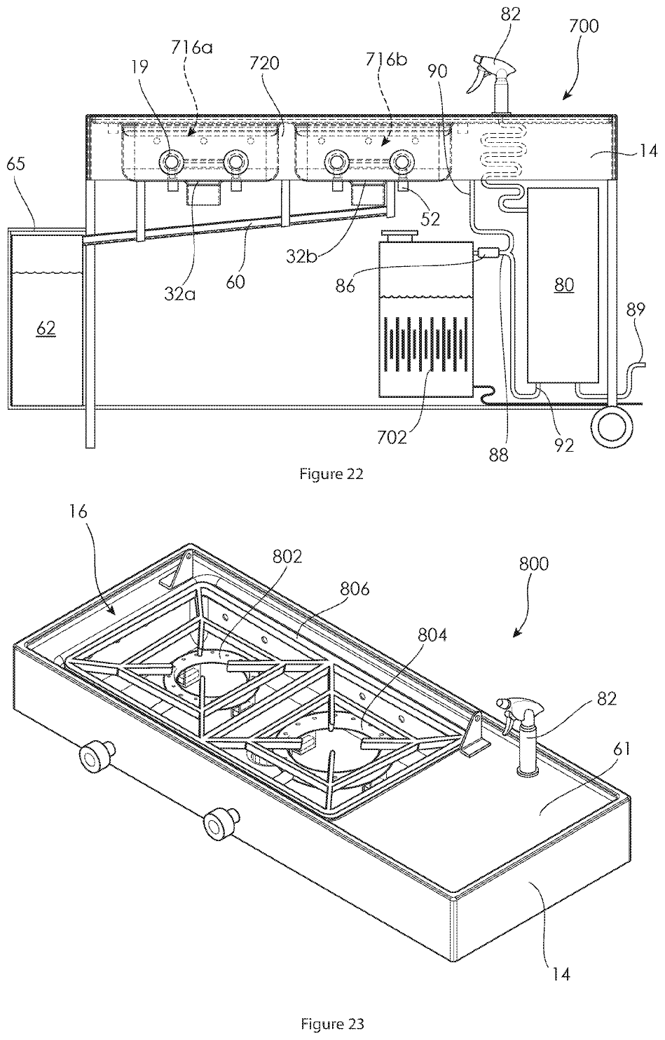

In FIG. 22, there is schematically depicted a further variation of a cooking apparatus 700 which again operates in generally the same manner as the cooking apparatus 10, 200, 300, 400, 500, and 600 described above, with like reference numerals being used to indicate like features. In this embodiment, an internal HHO generation machine 702 is to supply gas to the gas manifold of the cavity 16. The hot water module 80 described above is also fed by the HHO generation machine or could be an electrically heated unit. In the depicted embodiment, two cavities 716a and 716b are shown, which share a common top rail or edge 720 allowing the movement of cooking surfaces 20 across from one cavity to another. The two cavities 716a and 716b also have individual drains 32a and 32b, which then drain into a common channel 60 to direct fluid into the reservoir 72. This arrangement also creates an air gap to facilitate ventilation to dilute excess gas or fumes as well as facilitate an open flow of secondary air. The reservoir 62 may be covered by the covering or shroud 65 described above, and the covering or shroud 65 may also be held in place with magnet cage assemblies 320 described above. It will be appreciated that the concept of the internal HHO generation machine 702 and associated componentry described above may be integrated into any one of the embodiments of the cooking apparatus described herein.

In FIG. 23, there is schematically depicted a further variation of a cooking apparatus 800 which again operates in generally the same manner as the cooking apparatus 10, 200, 300, 400, 500, 600 and 700 described above, with like reference numerals being used to indicate like features. In this embodiment, the cooking apparatus 800 is in the form of a camp cooker or commercial kitchen hob, and illustrates how different sized and shaped burners 802 and 804, for example, may be interchanged with the burner 44 described above. Additionally, a pot stand 806 may be used instead of the cooking surface 20 described above, so to facilitate use of cooking pots or pans over the cavity 16. It will be appreciated that having the cooking apparatus 800 as a camp kitchen, the cooking apparatus 800 may be used to first perform cooking, then the burners may be removed and the apparatus 800 may be used to wash up the pots, pans and dishes, then be used to clean the burners, cooking surfaces and side surfaces.

Various forms of the cooking apparatus described above may have one or more of the following advantages. The ease of removal of the heat source 15, for example, the burner assemblies 17 or the charcoal box, housing, basket or tray 230, and also the smooth obstruction free shape of the cavity 16 with a drain 32, may at least allow the cavity 16 to be cleaned easily and efficiently. The smooth internal surfaces of the cavity are also less likely to accumulate matter such as grit and thereby the subject cooking apparatus may at least require less cleaning. Additionally, the ease of removal of other accessories such as the hood, rotisserie, splash back and also the smooth obstruction free shape of the work surfaces and surrounding edges which drain towards the cavity 16 may at least allow these surfaces to be cleaned easily and efficiently. The surfaces surrounding the cavity are also less likely to accumulate matter such as grit and thereby the subject cooking apparatus may require less cleaning. Further, the cooking apparatus and the various components described above may allow for an arrangement that is lasts longer (as the cooking apparatus in easier to maintain in good condition) and is more environmentally friendly (as the cooking apparatus does not need to be replaced as often as conventional barbeques). In arrangements whereby the cooking apparatus is in the form of a camp cooker, there is an additional advantage in that the cooking apparatus may have at least a dual purpose (i.e. used to cook and also to clean not only the cooking surfaces, burners and accessories, but also to clean the cooking utensils and crockery).

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any known matter or any prior publication is not, and should not be taken to be, an acknowledgment or admission or suggestion that the known matter or prior art publication forms part of the common general knowledge in the field to which this specification relates.

While specific examples of the invention have been described, it will be understood that the invention extends to alternative combinations of the features disclosed or evident from the disclosure provided herein.

Many and various modifications will be apparent to those skilled in the art without departing from the scope of the invention disclosed or evident from the disclosure provided herein.

1-21. (canceled)

22. A cooking apparatus including:
a burner assembly including at least one burner supported by a stand, the stand including a magnetically attractive material;
a body including a cavity in which the burner assembly is locatable and being adapted to support a cooking surface at least partially over the cavity, the cavity including a drain and substantially smooth surfaces arranged to direct a fluid to the drain;
a gas port fitted to the body to provide the at least one burner with gas; and
a magnet arranged to releasably couple with the magnetically attractive material of the stand;
wherein the cooking apparatus is configurable between:
a cooking mode in which the burner assembly is fitted to the gas port with the stand supported and located relative to cavity by the magnet, and the cooking surface is fittable at least partially thereover, and
a cleaning mode in which the cooking surface and burner assembly are removeable from the cavity, with the magnet being decoupled, to reveal the substantially smooth surfaces for cleaning with the fluid.

23. The cooking apparatus according to claim 22, wherein the cavity includes at least one side wall and a base that are formed substantially continuously.

24. The cooking apparatus according to claim 23, wherein the cavity is formed as a single piece having substantially smooth transitions between the at least one wall and base.

25. The cooking apparatus according to claim 24, wherein the cavity is formed of a unitary metal construction.

26. The cooking apparatus according to claim 22, wherein the drain is located in or at the base of the cavity.

27. The cooking apparatus according to claim 26, wherein the magnet is located in, at or below the base or side wall of the cavity.

28. The cooking apparatus according to claim 27, wherein the magnet includes one or more magnetic elements.

29. The cooking apparatus according to claim 22, wherein the stand of the burner assembly includes spaced apart legs arranged to coincide with the position of the magnet.

30. The cooking apparatus according to claim 29, wherein the legs include feet arranged to seat on the base, and wherein at least the feet are formed of the magnetically attractive material.

31. The cooking apparatus according to claim 30, wherein the magnet includes a plurality of magnetic elements fitted to an underside of the cavity and arranged to align with the feet of the burner assembly such that the burner assembly is drawn to a preferred location within the cavity.

32. The cooking apparatus according to claim 22, wherein the at least one burner is adapted to releasably attach to the gas port.

33. A cooking apparatus including:
a body including a cavity that is adapted to support a cooking surface at least partially over the cavity, the cavity including a drain and substantially smooth surfaces arranged to direct a fluid to the drain;
a heat source locatable in the cavity and supported by a stand;
wherein the cooking apparatus is configurable between:
a cooking mode in which the stand of the heat source is supported and located relative to cavity, and the cooking surface is fittable at least partially thereover, and
a cleaning mode in which the heat source is removeable from the cavity, to reveal the substantially smooth surfaces for cleaning with the fluid.

34. The cooking apparatus according to claim 33, wherein the stand includes a magnetically attractive material, and the cooking apparatus further includes a magnetic coupling means provided with the heat source, arranged to releasably couple with the magnetically attractive material of the stand, and wherein in the cooking mode, the stand of the heat source is supported and located relative to cavity by the magnetic coupling means, in the cleaning mode, the magnetic coupling means is decoupled.

35. The cooking apparatus according to claim 34, wherein the heat source is a burner assembly including at least one burner, or a charcoal housing, box, basket or tray having at least one integrated burner, and wherein the at least one burner includes a handle.

36. The cooking apparatus according to claim 35, further including a gas port fitted to the body to provide the at least one burner of the burner assembly or the charcoal housing, box, basket or tray with gas, and wherein in the cooking mode, the at least one burner of the burner assembly or the charcoal housing is fitted to the gas port.

37. The cooking apparatus according to claim 33, wherein the cavity includes at least one side wall and a base that are formed substantially continuously, and wherein the cavity is formed as a single piece having substantially smooth transitions between the at least one wall and base.

38. The cooking apparatus according to claim 34, wherein the magnetic coupling means is located in, at or below the base or side wall of the cavity or the body of the cooking apparatus, and the magnetic coupling means includes one or more magnetic elements.

39. The cooking apparatus according to claim 33, further including a magnetic coupling means in the form of one or more magnet cage assemblies arranged to releasably couple with one or more accessories of the cooking apparatus.

40. The cooking apparatus according to claim 33, further including a hand operable water source or spray jets to supply water to the cavity and to assist with cleaning the cooking apparatus, the hand operable water source or spray jets being fluidly connected to a hot water module.

41. The cooking apparatus according to claim 35, further including an induction coil assembly operatively associated with the at least one burner of the burner assembly or the at least one integrated burner of the charcoal housing, box, basket or tray.
